(19) United States
(12) Patent Application Publication
(10) Pub. No.: US 2003/0079002 A1
(43) Pub. Date: Apr. 24, 2003

(54) Computer-assisted equipment having a user interface configured according to a service program

(76) Inventor: William A. Fischer, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/004,089

(22) Filed: Oct. 23, 2001

(51) Int. Cl. G06F 15/177; G09G 5/00

(52) U.S. Cl. 709/221; 345/744

(57) ABSTRACT

A method of configuring a user interface of computer-assisted equipment according to a service program is disclosed. The method includes the computer-assisted equipment transmitting a message to the remote computer. The remote computer determines that a service program available on said remote computer is suitable for use with the computer-assisted equipment, wherein the determination is based on the message. The method continues with the remote computer influencing operation of the user interface of the computer-assisted equipment in accordance with the service program.

### BACKGROUND OF THE INVENTION

The invention relates generally to the field of computers and, more particularly, to the use of electronic equipment that communicates with a computer.

As users of industrial and consumer electronic equipment continue to demand increased capability at a lower cost, equipment manufacturers must continue to increase the functionality of their products in order to satisfy these users' demands. Thus, manufacturers of household and industrial appliances, entertainment devices, and other equipment must continue to design products that provide extensive functionality while presenting a simple and straightforward interface to the user.

Many pieces of equipment can be coupled to a personal computer by way of a communications link. This permits the equipment to be remotely controlled by the personal computer. According to this scenario, the computer-assisted equipment simply receives information from the remote computer and presents the information to the user. In turn, input from the user is conveyed back to the remote computer.

However, the scenario above does not permit flexibility in the equipment interface that is presented to the user. Additionally, the equipment and the service program that runs on the computer must typically be compatible along specific guidelines, thus making mismatch among equipment and the service program a common occurrence. Thus, it is highly desirable for computer-assisted equipment to configure the user interface of the equipment to the service available on a remote computer.

### BRIEF DESCRIPTION OF THE DRAWINGS

FIG. 1 represents a portion of the user interface of an audio reproduction system that communicates with a remote computer in accordance with a preferred embodiment of the invention;

FIG. 2 is an audio reproduction system that communicates with a remote computer in accordance with an alternate embodiment of the invention;

FIG. 3 is computer-assisted appliance that cooperates with a remote computer in accordance with a preferred embodiment of the invention;

FIG. 4 is a flowchart for a method of cooperatively operating a remote computer with a computer-assisted equipment in accordance with a preferred embodiment of the invention;

FIG. 5 is a flowchart for a method of cooperatively operating a computer-assisted equipment in accordance with a preferred embodiment of the invention;

FIG. 6 is a flowchart for a method of operating a remote computer that cooperates with a computer-assisted equipment in accordance with a preferred embodiment of the invention; and

FIG. 7 is a flowchart for a method of operating a remote computer with a computer-assisted equipment in accordance with a preferred embodiment of the invention.

### DESCRIPTION OF THE PREFERRED EMBODIMENTS

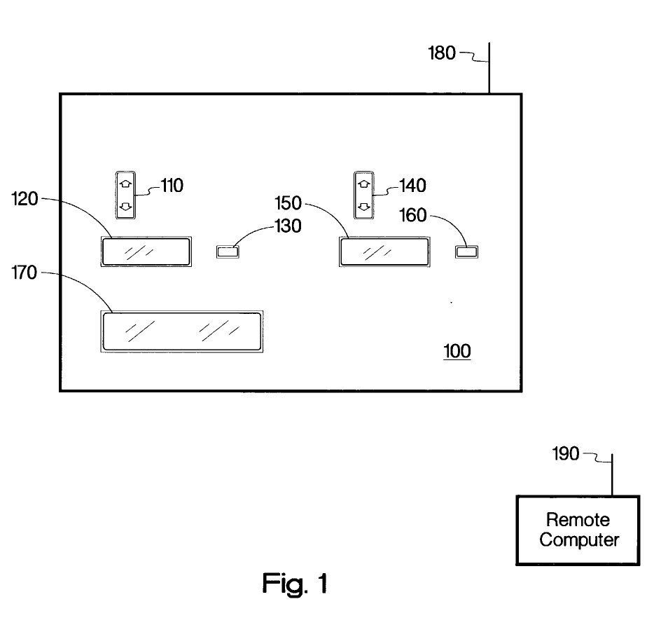

FIG. 1 represents a portion of the user interface of an audio reproduction system that communicates with a remote computer in accordance with a preferred embodiment of the invention. In FIG. 1, audio reproduction system 100 communicates wirelessly with remote computer 300 using antenna 180. Audio reproduction system 100 does not possess any prior knowledge of services that are offered by remote computer 300. The user interface of audio reproduction system 100 need only possess the capability for at least a portion of its user interface to be defined by a computer program that runs on the audio reproduction system.

Remote computer 300 includes antenna 190, which receives and transmits information to and from audio reproduction system 100. Preferably, both audio reproduction system 100 and remote computer 300 include a Bluetooth, IEEE 802.11b, or other interface that enables wireless communications. Alternatively one or both of system 100 and remote computer 300 include hardware and software that bring about wireless communications according to other standards and protocols used to enable communications among computers and other equipment.

In FIG. 1, remote computer 300 represents a general-purpose computing device, such as a laptop computer, desktop computer, or handheld computer capable of executing various applications or service programs. Remote computer 300 can also be a special purpose computing device adapted to remotely control computer-assisted equipment.

In FIG. 1, remote computer 300 executes one or more service programs that cooperate with audio reproduction system 100 by way of a wireless interface. Thus, remote computer 300 may run a service program that cooperates with audio reproduction system 100 to play compact disc (CD) selections available on a CD changer that is coupled to the remote computer. Simultaneously, the remote computer may run a service program that enables the audio reproduction system to select and play MP3 files stored on media resident within the remote computer. Further, remote computer 300 may be simultaneously executing other programs, such as word processing and Internet browsing, while communicating with the audio reproduction system. Although there is no limit to the number of service programs that can be executed on remote computer 300, it is envisioned that between two and eight programs are available; however, a lesser or greater number of service programs can be available according to the capabilities of remote computer 300.

In the example of FIG. 1, program select switch 110 is a toggle switch or a rocker switch used to select the source for the music selections being reproduced by audio reproduction system 100. Program select switch 110 enables the user to list the various available services. Thus, as the user depresses the up and down arrow of program select switch 110, the names or other identifiers of the various service programs available on remote computer 300 are displayed.

Program select descriptor 120 displays a name or other identifier of the services that are available to audio reproduction system 100. Thus, program select display 120 may indicate “MP3 Music Server” to denote a service program that plays music stored as MP3 files in on an internal disk of remote computer 300. When the user depresses the up or down arrow of program select switch 110 a second time, program select descriptor 120 may indicate “Internet Broadcast” to indicate that a program for conveying Internet broadcasts from remote computer 300 to audio reproduction system 100 is available. Further depressing of program select switch 110 may result in the display of additional service programs running on remote computer 300 that are available for use by audio reproduction system 100.

In the example of FIG. 1, the user of audio reproduction system 100 may begin by selecting the service program that remote computer 300 uses to interface with the audio reproduction system. When the service has been selected, the remote computer conveys the interface instructions required for the audio reproduction to cooperate with the remote computer in accordance with the selected service program. Thus, in the example of FIG. 1, if the user were to select the “Internet Broadcast” service program, remote computer 300 can begin by conveying instructions that program or configure the input devices, such as program select switch 110, that allow the user to select one of a list of Internet broadcast stations conveyed by way of remote computer 300. Remote computer 300 then conveys a list of Internet broadcast stations or other resources available at various network locations on the network.

In the event that the user selects “MP3 Music Server”, remote computer 300 desirably conveys interface instructions that allow the user to select several titles so that each title can be played according to a selected order (such as sequential, random, and so forth). The remote computer can then convey a list of stored MP3 titles available on a disk or other media accessible by the remote computer.

Audio reproduction system 100 also includes audio selection switch 140, which allows the user to scroll through the individual audio selections that can be transmitted from remote computer 300 to audio reproduction system 100. These individual audio selections are presented to the user by way of audio selection display 150 and selected by way of the user depressing audio select button 160. Thus, in event that the user selects a service program that conveys Internet broadcast content to system 100, the Universal Resource Locator (URL) of the Internet broadcast station is presented to the user by way of audio selection display 150. In the event that the user selects to play stored MP3 files, the interface instructions that control the selected service program conveyed from remote computer 300 allow the user to select more than one selection so that a play list can be constructed and displayed.

The function performed by audio selection switch 140 can be implemented using a knob or other means of switching between audio selections other than the switch shown in FIG. 1. In this embodiment, audio reproduction system 100 implements the selection function by assigning each detent position to represent a particular MP3 selection, URL, or other label, with each selection being presented to the user by way of audio select display 150. In fact, any number of audio equipment types can cooperate with remote computer 300 provided that the particular equipment includes control and display functions that can be programmed by a remote computer. Thus, whether the selection function is implemented by allowing each detent position to represent a particular MP3 selection, URL, or other label, audio reproduction system 100 is able to perform the selection function of system 100 in a flexible manner that accords with the particular capabilities of the equipment as well as those of the service programs available on remote computer 300.

In FIG. 1, system display 170 is configured for operation by the service program running on remote computer 300. Under the control of the selected program, system display 170 can present visual images, such as a kaleidoscope, music video, or other content, that complements the audio being supplied to audio reproduction system 100. Thus, system display 170 can display moving or still pictures that accompany the audio being reproduced on system 100. System display 170 can also perform the functions related to the audio select display 150 by displaying text data such as a play list or other information.

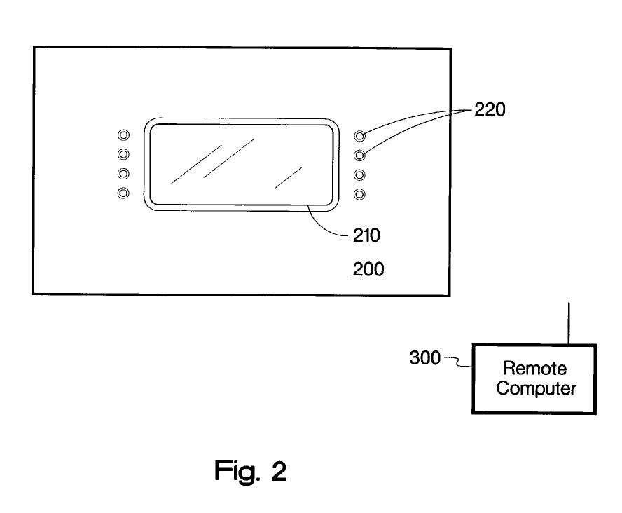

FIG. 2 is an audio reproduction system that communicates with a remote computer in accordance with an alternate embodiment of the invention. As is the case with FIG. 1, only a portion of the user interface is shown. In FIG. 2, display 210 represents the predominant interface used by audio reproduction system 200 to present selections from remote computer 300 according to the selected service program running on remote computer 300. Desirably, a substantial portion of the user interface that controls audio reproduction system 200, as well as the presentation of information to the user of system 200, are facilitated by the combination of display 210 and selectors 220.

In FIG. 2, display 210 displays images that complement music selections, or may be capable of displaying only text, such as the titles of particular selections or a URL indicating the source of an audio broadcast. In either case, the display capability of display 210 need not impact the operator selection of a particular service program. For example, if display 210 has only limited display capability, information transmitted from remote computer 300 that is beyond the capability of display 210 can be ignored by audio reproduction system 200. This allows audio reproduction system 200 to adapt to the service program available on remote computer 300.

In another example, if the user has selected a service program that plays MP3 files stored on an internal disk of remote computer 300, at least some of selectors 220 can be used to select from different directories that hold MP3 files on the remote computer's internal disk. Some portion of display 210 can also be configured to provide a play list of titles selected by the user.

In an alternate embodiment, display 210 represents a display of a video entertainment system. Selectors 220 can be placed either on the face of the entertainment system (as shown), or can be implemented in a remote control device that receives commands from the user and transmits these to a remote computer. In either case, however, the functions performed by the selectors comply with the service program running on remote computer 300. Thus, in the event that display 210 is displaying a sports event broadcast by way of an Internet audio and video source conveyed to display 210 by way of remote computer 300, the service program selected for use by display 210 can program one or more of selectors 220 to perform a freeze frame, instant replay, display pertinent text information, or perform another function that enhances the user's experience. In this embodiment, the video entertainment system receives some types of content, such as audio, video images, and text, while the remote control device receives interface instructions as well as controlling the content transmitted from the remote computer to the display.

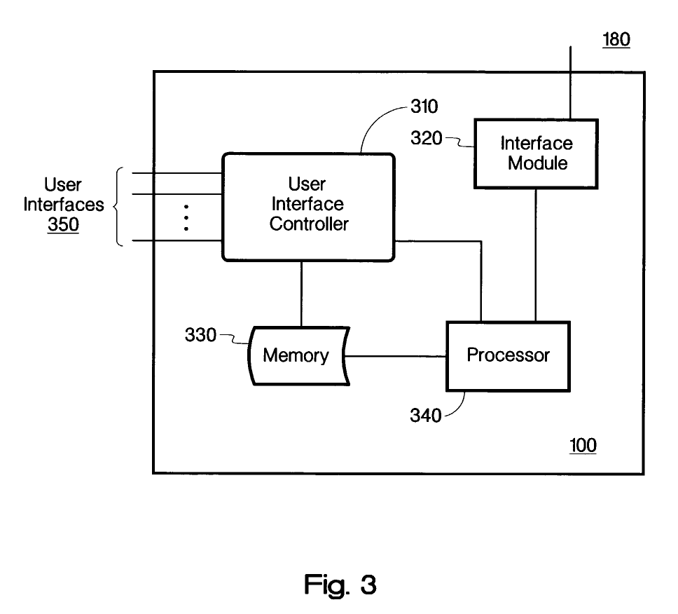

FIG. 3 is computer-assisted appliance that cooperates with a remote computer in accordance with a preferred embodiment of the invention. In FIG. 3, interface module 320 receives and transmits information by way of antenna 280. Interface module 320 may operate by way of a Bluetooth, IEEE 802.11b or other interface that enables wireless communications between the equipment and the remote computer. Interface module 320 is coupled to processor 340, which receives data from the interface module and interprets the received data as relating to content or interface instructions. Interface module 320 can also communicate with associated equipment (such an entertainment system) by way of a remote control function.

In the event that processor 340 determines that user interface instructions have been received, the instructions are forwarded to user interface controller 310. The data is used by user interface controller 310 so that a desired function can be implemented by the computer-assisted appliance. An example of an interface instruction could be a display function in which various text data are to be displayed to a user, and that the user should select one entry from the list. In this case, the interface instruction could indicate the need for a capability of a textual list display by the appliance, the need to scroll among the entries of the list, as well as a need for the user to select a single entry from the list. In turn, user interface controller 310 converts the received instruction into at least one appliance-specific instruction according to the particular display capabilities of the appliance as well as the input capabilities of user interfaces 350. The appliance-specific instructions are stored in memory 330.

When content data is received (such as a portion of an MP3 file), processor 340 places the data in an appropriate location within memory 330, which buffers the incoming content. Although compressed file formats (such as MP3) desirable for use with the embodiment of FIG. 3, other compressed or uncompressed file formats can be used.

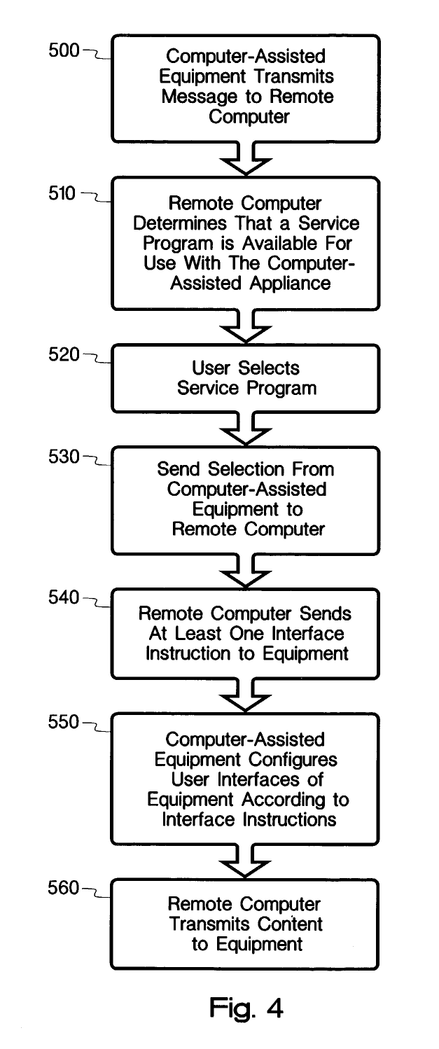

FIG. 4 is a flowchart for a method of cooperatively operating a remote computer with a computer-assisted equipment in accordance with a preferred embodiment of the invention. The method begins at step 500 in which the computer-assisted equipment transmits a service request message that identifies the computer-assisted equipment to the remote computer. Preferably, step 500 is executed upon startup of the computer-assisted equipment wherein the equipment begins searching for a service with which the computer-assisted equipment can cooperate. Thus, in accordance with the example of FIG. 1, an audio reproduction system may initiate its operation by searching for a service provided by remote computer capable of supplying the equipment with MP3 files for presentation to a user.

At step 510, the remote computer determines that a service program suitable for use with the computer-assisted equipment is available. Desirably, this step is performed in response to the receipt of the message transmitted by the computer-assisted equipment in step 500. For example, the user of an audio reproduction system may select a service program that does not require substantial interaction with the system once the service program has been selected and the system has been configured. Thus, the user may select a program that transmits MP3 files to the system and instructs the system to play each selection at a medium volume level. This allows the user to hear selections stored on a remote computer by way of an audio reproduction system without needing to further interact with the system. The remote computer determines (at step 510) that other service programs are available for use by the computer-assisted equipment. A description of these services can be broadcast along with the requirements (such as display and selection capability) for the use of the services. The remote computer then waits for particular equipment types (such as an audio or video reproduction system) to respond when a service is desired.

At step 520, the user selects the desired service program from among the alternatives. Step 520 can be performed in response to the remote computer sending the service description to the computer-assisted equipment so that the user can choose the service program based on the description, rather than by a name only. In step 530, this selection is sent from the computer-assisted equipment to the remote computer.

In step 540, the remote computer transmits one or more interface instructions required by each particular service program available on the remote computer. These interface instructions inform the equipment of the inputs that cause the remote computer to execute a portion of a particular service program. Thus, for a service program that requires no user input after the program has been selected, the remote computer can simply indicate to the computer-assisted equipment (e.g. an audio reproduction system) a “start” and “stop” function is all that is required to control the flow of streaming audio.

In another example, in accordance with the embodiment of the audio reproduction system of FIGS. 1 or 2, the remote computer indicates that the system should have a display capability (in order to display music selections), a single selection function (in order to allow the user to select from one or more of the music selections), as well as a speaker function. The remote computer may also indicate to the system that music videos are available for display if the system can present these images to a user.

Preferably, the interface instructions transmitted in step 540 include the manner in which the computer-assisted equipment conveys particular interface functions to the remote computer. For example, in the case of the audio reproduction system of FIGS. 1 or 2, these interface instructions would desirably include the manner in which the list of music selections will be conveyed to the audio reproduction system (i.e. hypertext markup language, ascii text, and so forth). These instructions preferably would also include the specific data desired from the audio reproduction system indicating that a user has selected a particular selection. Further, these instructions would likely include the manner in which content (e.g. audio and video) information is separated from text information in communications from the remote computer.

At step 550, the computer-assisted equipment configures the user interfaces of the equipment in accordance with the service program selection made by the user in step 520. This may include enabling the equipment to accept user inputs in a specified manner. For the example of FIG. 2, this step would desirably include the audio reproduction system identifying which of selectors 220 will be used to select from the list of available music selections, as well as which of selectors 220 will the used for other functions. In step 560, remote computer 560 transmits content, and perhaps text as well, according to the interface instructions provided in step 540.

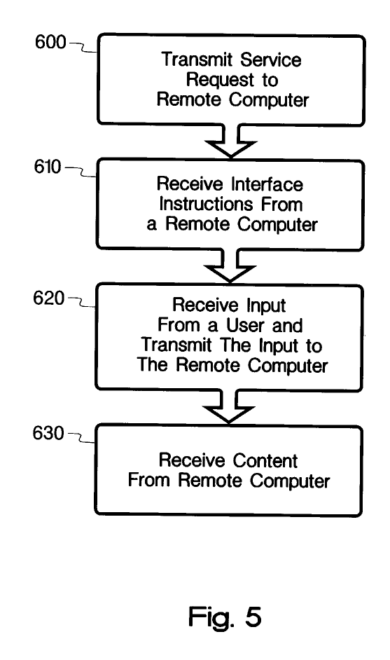

FIG. 5 is a flowchart for a method of cooperatively operating a computer-assisted equipment in accordance with a preferred embodiment of the invention. At step 600 a computer-assisted equipment transmits a service request to a remote computer. The service request provides an indication that the computer-assisted equipment is ready and available to receive an interface instruction from the remote computer. At step 610, the computer-assisted equipment receives at least one interface instruction from the remote computer in response to the service request. Preferably, the received interface instruction enables the computer-assisted equipment to cooperatively operate with the remote computer by presenting information to a user and receiving inputs from the user. Step 610 can also include the presentation of a number of service programs that are available for use by the computer-assisted equipment as well as receiving a selection from a user that a particular program is desired.

In step 620 the computer-assisted equipment receives input from a user and transmits these to the remote computer in accordance with the received interface instructions. Step 620 is followed by step 630, which includes the computer-assisted equipment receiving content from the remote computer in accordance with the service program.

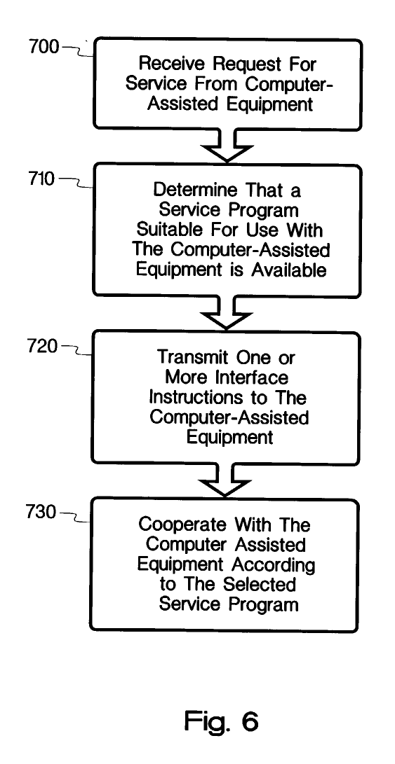

FIG. 6 is a flowchart for a method of operating a remote computer that cooperates with a computer-assisted equipment in accordance with a preferred embodiment of the invention. In step 700, a remote computer receives a request for service from the computer-assisted equipment. Desirably, the service request indicates that the computer-assisted equipment is ready to operate cooperatively with the remote computer. In step 710, the remote computer determines that a service program suitable for use with the computer-assisted equipment is available. Step 710 can also include the remote computer receiving a selection as to which service program has been selected by the user of the computer-assisted equipment.

In step 720, the remote computer transmits one or more interface instructions to the computer-assisted equipment. In step 730, the remote computer cooperates with the computer-assisted equipment in accordance with the service program. Step 730 may entail transmitting content, such as MP3 files, to the computer-assisted equipment in response-to an operator inputs. Preferably the selected service program controls the transmission of the content transmitted in step 730. Step 730 can also include the remote computer obtaining content and communicating with a network, such as the Internet.

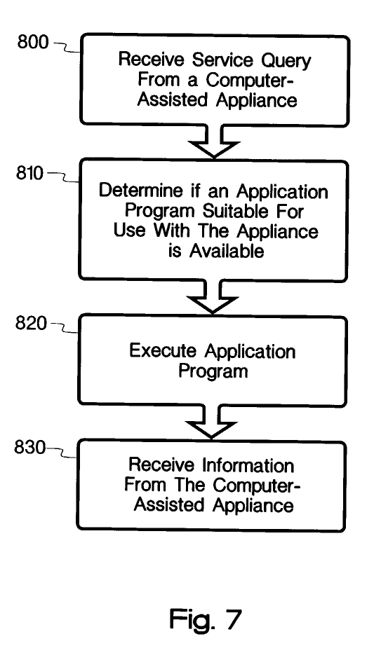

FIG. 7 is a flowchart for a method of operating a remote computer with a computer-assisted equipment in accordance with a preferred embodiment of the invention. The steps of the method of FIG. 7 can be stored on one or more computer-readable media having computer-readable instructions thereon which, when executed by a computer, cause the computer to perform the method. The method begins at step 800, in which the remote computer receives a service query from a computer-assisted appliance. Step 800 can include receiving an indicator that informs the computer of a function performed by the computer-assisted appliance. In step 810, the remote computer determines that an application or service program suitable for use with the computer-assisted appliance is available. Step 810 can include the computer searching through a list of application programs prior to the determining step.

In step 820, the computer executes the selected application program. Step 820 can include the remote computer transmitting interface instructions to the computer-assisted appliance that informs the appliance of the type of data transmitted from the remote computer to the appliance, as well as the data needed from the appliance.

In step 830, the computer receives information from the computer-assisted appliance in compliance with the service program. This information may include an input from a user of the computer-assisted appliance. The received input may be the result of a prompt that solicits an input from the user.

What is claimed is:

1. A method of configuring a user interface of computer-assisted equipment according to a service program, comprising the steps of:
said computer-assisted equipment transmitting a message to a remote computer;
said remote computer determining that said service program available on said remote computer is suitable for use with said computer-assisted equipment, said determining being based on said message; and
said remote computer influencing operation of said user interface of said computer-assisted equipment in accordance with said service program.

2. The method of claim 1, wherein said computer-assisted equipment provides entertainment.

3. The method of claim 2, wherein said computer-assisted equipment is an audio reproduction system.

4. The method of claim 1, wherein said computer-assisted equipment is a remote control device that controls functions of a video entertainment system, said video entertainment system receiving content from said remote computer.

5. The method of claim 1, wherein said determining step includes said remote computer informing said computer-assisted equipment that at least one additional service program is available, said computer-assisted equipment selecting from among said service program and said at least one additional service program.

6. The method of claim 5, additionally comprising said remote computer receiving a selection from said computer-assisted equipment, said selection indicating which of said service program and said at least one additional service program a user has selected.

7. The method of claim 1, wherein said remote computer is a general-purpose computer.

8. The method of claim 1, wherein said message is a service request that indicates that said computer-assisted equipment is ready to operate cooperatively with said remote computer.

9. The method of claim 1 further comprising said remote computer transmitting content to said computer-assisted equipment under the control of said service program.

10. In a computer-assisted appliance, a method for interacting with a remote computer that executes a service program, comprising the steps of:
transmitting a service request to said remote computer;
receiving an interface instruction that enables said remote computer to execute a portion of a particular service program;
transmitting a user input to said remote computer in accordance with said interface instruction; and
receiving content from said remote computer in response to said interface instruction.

11. The method of claim 10, wherein said service request includes an indication that said computer-assisted appliance is available and is ready to receive said service program.

12. The method of claim 10, wherein said remote computer is one of a portable and a desktop computing device.

13. The method of claim 9, wherein said appliance is an audio system that conveys music, and wherein said content includes a music file.

14. The method of claim 13, wherein said user input is a selection of a title of said music file.

15. The method of claim 13, wherein said service program includes instructions that enable said audio system to display a list of music selections.

16. The method of claim 10, wherein said service program influences the function of a display located on said computer-assisted appliance.

17. The method of claim 10, wherein said service program influences a function of a remote control device used to control an entertainment device.

18. A computer-assisted appliance comprising:
an interface module for communicating with a remote computer and for receiving an interface instruction from said remote computer;
a processor for translating said interface instruction into an appliance-specific instruction for use by said computer-assisted appliance; and
a user interface controller for presenting information to a user and receiving information from said user in accordance with said appliance-specific instruction.

19. The computer-assisted appliance of claim 18, wherein said interface module communicates with said remote computer by way of a wireless communications interface.

20. The computer-assisted appliance of claim 18, wherein said interface module also remotely controls a video entertainment system by way of a wireless interface.

21. The computer-assisted appliance of claim 18, wherein said appliance-specific instruction enables said computer-assisted appliance to display text to said user via a user interface coupled to said user interface controller.

22. The computer-assisted appliance of claim 18, wherein said appliance-specific instruction enables said computer-assisted appliance to display graphics to said user via a user interface coupled to said user interface controller.

23. The computer-assisted appliance of claim 18 further comprising a memory coupled to said processor for storing content received by way of said interface module.

24. In a remote computer, a method for cooperating with computer-assisted equipment, comprising the steps of:
receiving a request for service from said computer-assisted equipment;
determining that a service program suitable for use with said computer-assisted equipment is available, said service program including an interface instruction;
transmitting said interface instruction to said computer-assisted appliance; and
cooperating with said computer-assisted appliance in accordance with said service program.

25. The remote computer of claim 24, wherein said determining step includes receiving a selection as to which service program has been selected by a user of said computer-assisted equipment.

26. The remote computer of claim 24, wherein said remote computer is interfaced to a network and wherein said remote computer communicates with a network location available on said network.

27. The remote computer of claim 24, wherein said transmitting step is accomplished by way of transmitting said interface instruction using a wireless interface.

28. A computer-assisted appliance comprising:
means for communicating with a remote computer;
means for receiving an instruction from said remote computer;
means for converting said instruction to at least one appliance-specific instruction; and
means for accepting an input from a user in accordance with said appliance-specific instruction.

29. The computer-assisted appliance of claim 28, wherein said means for communicating with said remote computer includes a wireless communications transmitter.

30. The computer-assisted appliance of claim 28, wherein said means for receiving an instruction from said remote computer includes a wireless communications receiver.

31. The computer-assisted appliance of claim 28 further comprising means for displaying information to a user of said computer-assisted appliance.

32. The computer-assisted appliance of claim 28, further comprising means for remotely controlling an entertainment device.

33. One or more computer-readable media having computer-readable instructions thereon which, when executed by a computer, cause the computer to perform a method comprising the steps of:
receiving a service query from a computer-assisted appliance;
determining that an application program suitable for use with said computer-assisted appliance is available;
configuring an interface of said computer-assisted appliance; and
receiving information from said computer-assisted appliance, said information being conveyed from said interface and resulting from a user interacting with said interface.

34. One or more computer-readable media as recited in claim 33, wherein said receiving a service query step includes receiving an indicator that informs said computer of a function performed by said computer-assisted appliance.

35. One or more computer-readable media as recited in claim 33, wherein said determining step includes said computer searching through a list of application programs.

36. One or more computer-readable media as recited in claim 33, wherein said method further comprises said computer-assisted appliance prompting said user for said input.
